(19) United States
(12) Patent Application Publication
(10) Pub. No.: US 2009/0104943 A1
(43) Pub. Date: Apr. 23, 2009

(54) MOBILE TERMINAL HAVING TOUCH SCREEN AND METHOD FOR INPUTTING LETTER THEREIN USING TOUCH SCREEN

(75) Inventors: Won Joo Park, Gwacheon-si (KR); Hyungn Min Yook, Seoul (KR); Min Suk Jang, Anyang-si (KR); Mi Jung Park, Hwaseong-si (KR); Keun Young Kim, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/244,489

(22) Filed: Oct. 2, 2008

(30) Foreign Application Priority Data
Oct. 17, 2007 (KR) 10-2007-0104708

(51) Int. Cl. H04B 1/38

(52) U.S. Cl. 455/566

(57) ABSTRACT

A method of efficiently inputting a desired letter in a mobile terminal having a touch screen by providing an automatic input mode. In order to input a letter located at at least the second location in a key, the user may just maintain the first touch to sequentially display the letters allocated to the key without continuously touching the touch screen. When a letter desired by the user is displayed on a display, input of the letter may be fixed upon release of the touch. The speed at which a letter is changed is determined by a learning operation of a control unit.

### CROSS REFERENCE TO RELATED APPLICATION

This application claims priority from and the benefit of Korean Patent Application No. 10-2007-0104708, filed on Oct. 17, 2007, which is hereby incorporated by reference for all purposes as if fully set forth herein.

### BACKGROUND OF THE INVENTION

1. Field of the Invention

The present invention relates generally to a mobile terminal having a touch screen and a method for inputting a letter in the mobile terminal using a touch screen, and, more particularly, to inputting a desired letter with a single touch using an automatic input mode when a plurality of letters are allocated to a single key.

2. Discussion of the Background

In recent years, mobile terminals have become multimedia devices that provide various additional services such as an electronic diary, games, and schedule management functions. As mobile terminals provide various additional services, it is often necessary to input various types of letters to the mobile terminals. Accordingly, various methods for more conveniently inputting information, such as letters, into mobile terminals are being suggested. Methods for inputting letters using a touch screen are being spotlighted. A touch screen refers to a display unit designed to recognize a touched portion of the screen upon a direct touch of the screen by a finger of the user or a touch pen having the shape of a ballpoint pen, and execute a command or move the location of the cursor according to the touched portion. A touch screen may be classified, based on its operational principles, as a pressure sensitive touch screen that is sensitive to pressure applied to a screen surface, an electrostatic touch screen to recognize a contact portion by detecting a lost charge, an infrared touch screen to detect a contact portion by detecting a blocked infrared ray, and the like.

When inputting letters in a mobile terminal, a user may select one of a group of letters allocated to a number key, by tapping a number key multiple times. When using hard keys, the user may easily detect the location of a key to which a letter, which is to be input to the mobile terminal, is allocated using the tactile sense of his or her fingertip even in the case of multiple tapping. Upon input of a letter, the user also may easily check input of a letter on a display unit of the mobile terminal. However, unlike with hard keys, when the user taps a key on a touch screen multiple times, the user may need to concentrate his or her attention to continuously press the same key. Furthermore, when continuous input of the same letter is desired, the user may need to wait until the cursor representing the input location of the letter moves, in order to input the next letter after completion of input of the current letter.

Accordingly, there is a demand for an automatic input mode to input a desired letter with a single touch. Furthermore, there also is a demand for a function for inputting a next letter without waiting for movement of the cursor, so as to promptly input the next letter.

### SUMMARY OF THE INVENTION

The present invention provides a method for easily inputting a letter desired by the user when a plurality of letters are allocated to a single key in a mobile terminal using a touch screen.

The present invention also discloses a mobile terminal capable of performing the method.

Additional features of the invention will be set forth in the description which follows, and in part will be apparent from the description, or may be learned by practice of the invention.

The present invention discloses a mobile terminal including a touch screen and a control unit. The control unit receives a coordinate corresponding to a point where a touch has occurred on the touch screen and displays a letter corresponding to the coordinate. When the touch is maintained for a specific time period in an automatic input mode, the control unit controls the display to output the next letter after a lapse of a learning time period. The control unit may learn the letter change period in the automatic input mode by determining a time period for which a key is continuously pressed by the user in a manual input mode.

The present invention also discloses a method for inputting a letter in a mobile terminal using a touch screen, the method including generating a touch generation signal upon occurrence of a touch, determining a location where the touch has occurred, displaying a letter corresponding to the location on a display unit, determining a time period for which the touch is maintained, and changing the letter displayed on the display unit when the time period for which the touch is maintained exceeds a letter change period.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a mobile terminal according to an exemplary embodiment of the present invention;

FIG. 2 is a flowchart showing a process of learning the letter input speed of the user and providing an automatic input mode by a mobile terminal according to an exemplary embodiment of the present invention.

FIG. 3 is a flowchart showing a process of inputting a letter using the automatic input mode according to an exemplary embodiment of the present invention.

FIG. 4 is a view showing the inputting of a small alphabet letter ‘c’ in the automatic input mode according to an exemplary embodiment of the present invention.

FIG. 5 is a flowchart showing a process of determining the number of letters deleted due to erroneous inputs by the user and adapting the letter change period in the automatic input mode according to an exemplary embodiment of the present invention.

FIG. 6 is a flowchart showing a process of determining the occurrence of a deletion event due to an erroneous input by the user in real time and correcting the letter change period in the automatic input mode according to the exemplary embodiment of the present invention.

FIG. 7 is an example of sequentially displaying a plurality of letters allocated to one key during maintenance of a touch on a touch screen by the user in the automatic input mode according to the exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

A mobile terminal according to an exemplary embodiment of the present invention may be a personal digital assistant (PDA) terminal, a smart phone, and an international mobile telecommunication (IMT) 2000 terminal, as well as a general mobile terminal.

In the present invention, a ‘manual input mode’ refers to a mode in which a key is directly and continuously pressed to enable the user to input one of a plurality of letters allocated to the key. An ‘automatic input mode’ refers to a mode in which, when a touch is maintained on a touch screen to enable the user to input one of a plurality of letters allocated to one key, the letters displayed on a display are sequentially changed at intervals.

Furthermore, a ‘letter change period’ refers to a time period after which the currently displayed letter is changed to the next letter when the user maintains a touch on a touch screen in the automatic input mode.

Hereinafter, exemplary embodiments of the present invention will be described in detail with reference to the accompanying drawings.

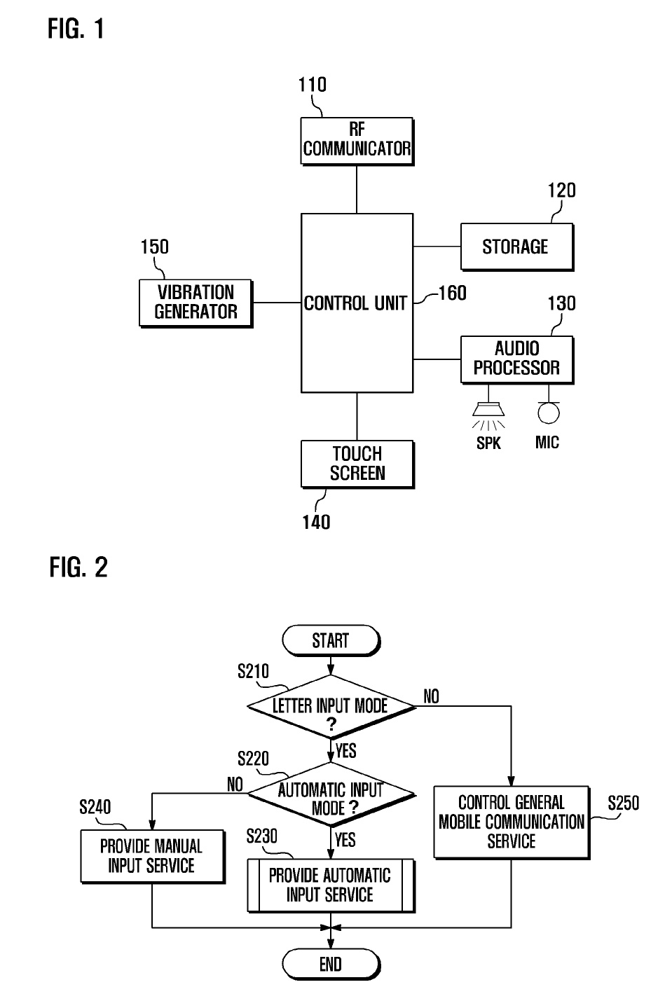

FIG. 1 is a block diagram showing a mobile terminal according to an exemplary embodiment of the present invention. The mobile terminal may include a radio frequency (RF) communicator 110, a storage unit 120, an audio processor 130, a touch screen 140, a vibration generator 150, and a control unit 160.

The RF communicator 110 includes an RF transceiver and a duplexer, and performs a general function of a mobile terminal, such as processing RF transmission and reception.

The storage unit 120 stores programs and data used for the overall operation of the mobile terminal. In particular, in the exemplary embodiment of the present invention, the storage unit 120 may store a program related to the automatic input mode.

The audio processor 130 may include a microphone to output an audio signal and a speaker.

The touch screen 140 may include a display unit and a touch pad attached to the display unit. The touch screen 140 displays various display data generated in the mobile terminal, the operational state of the mobile communication, and letters input by the user. The touch screen 140 determines the location of a point where a touch has occurred by detecting a touch occurring on the touch screen. The touch screen may be classified, based on its operational principles, as a pressure sensitive touch screen that is sensitive to pressure applied to a screen surface, an electrostatic touch screen to recognize a contact portion by detecting a lost charge, an infrared touch screen to detect a contact portion by detecting a blocked infrared ray, and the like, but any type of touch screen may be used.

Upon the occurrence of an event, such as reception of a call or an alarm, the vibration generator 150 generates mechanical vibration to enable the user to detect shaking of the mobile terminal. In particular, when a letter is input or changed in the automatic input mode, the vibration generator 150 may generate vibration in the mobile terminal. A vibration generated due to the input or change of a letter may have an amplitude and a period different from those of a vibration generated due to the occurrence of an event, such as reception of a call or an alarm. A user may detect the input or change of a letter on the display unit by a corresponding vibration.

The control unit 160 controls the overall operation of the mobile terminal. In particular, upon the occurrence of a touch on the touch screen 140 of the mobile terminal, the control unit 160 receives a touch detection signal generated in the touch screen 140 and a location of a point where the touch has occurred and controls the display unit to display a letter corresponding to the location. The control unit 160 determines how long the touch is maintained when in the automatic input mode, and when the touch on the touch screen is maintained for more than a letter change period, upon the lapse of the letter change period, the letter displayed on the display is sequentially changed to a next letter allocated to the same key as the currently displayed letter. In the automatic input mode, the control unit 160 controls the vibration generator 150 to enable the user to recognize the change of the letter by generating vibration in the mobile terminal when the letter changes.

The control unit 160 may learn the speed at which letters are input by the user and determine or correct the letter change period for change of a letter and generation of vibration in the automatic input mode accordingly. That is, the control unit 160 learns the letter input speed of the user while the user is inputting a letter using the touch screen in the manual input mode. In particular, the control unit 160 determines the time for which the user continuously presses a same letter and determines the letter change period of the user. While the user maintains the touch on the touch screen 140 in the automatic input mode, upon lapse of the learned letter change period, the control unit 160 sequentially changes the letter.

The control unit 160 may learn a letter change period in the automatic input mode, as well as the manual input mode. In this case, when in the automatic input mode, the control unit 160 checks a situation in which the finished letter is deleted due to an erroneous input. Based on this, the control unit 160 determines whether the letter change period provided in the automatic input mode is appropriate. When a finished letter is deleted by the user, the control unit 160 determines that the letter was changed too rapidly and increases the letter change period. In other words, the control unit 160 lengthens the time before a letter is changed. In the above-mentioned method, the control unit 160 may precisely adapt a letter change period, even in the automatic input mode.

That is, the control unit 160 determines a letter change period by learning a letter input speed of the user in the manual input mode. Then, the control unit 160 determines the time for which a touch is maintained on the touch screen 140 in the automatic input mode, and sequentially changes the input letter whenever the letter change period elapses. Then, the control unit 160 may check when a finished letter is deleted due to an erroneous input of the user, and may increase the letter change period accordingly if needed. The control unit 160 determines a letter change period in the automatic input mode via the above-mentioned learning process.

FIG. 2 is a flowchart showing a process of learning the letter input speed of the user and providing an automatic input mode by a mobile terminal according to an exemplary embodiment of the present invention.

First, a control unit 160 of the mobile terminal determines whether the mobile terminal is in a letter input mode (S210). When the mobile terminal is in the letter input mode, the control unit 160 determines whether the letter input mode is based on an automatic input mode (S220). The automatic input mode of the mobile terminal refers to a mode in which the letter displayed on a display is sequentially changed when a touch on a touch screen is being maintained, in order to enable the user to input one of a plurality of letters allocated to a single key. When the mobile terminal is in the automatic input mode, the control unit 160 provides an automatic input service (S230). When the letter input mode is not based on the automatic input mode, the control unit 160 provides a manual input service (S240). The manual input service refers to direct and continuous pressing of a single key to enable the user to input one of a plurality of letters allocated to the key. In the manual input service, the control unit 160 may perform a learning procedure to determine the letter change period in the automatic input mode. That is, when a location is tapped multiple times to input a next letter allocated to the same key as the current letter, the control unit 160 determines the time period for which the key is continuously pressed. The control unit 160 determines a letter change period in the automatic input mode based on the time period. Then, while the user is maintaining a touch on the touch screen in the automatic input mode, the letter allocated to the touched key is sequentially changed whenever the letter change period elapses. On the other hand, when the control unit 160 determines that the mobile terminal is not in the letter input mode at step S210, it provides a general mobile communication service (S250).

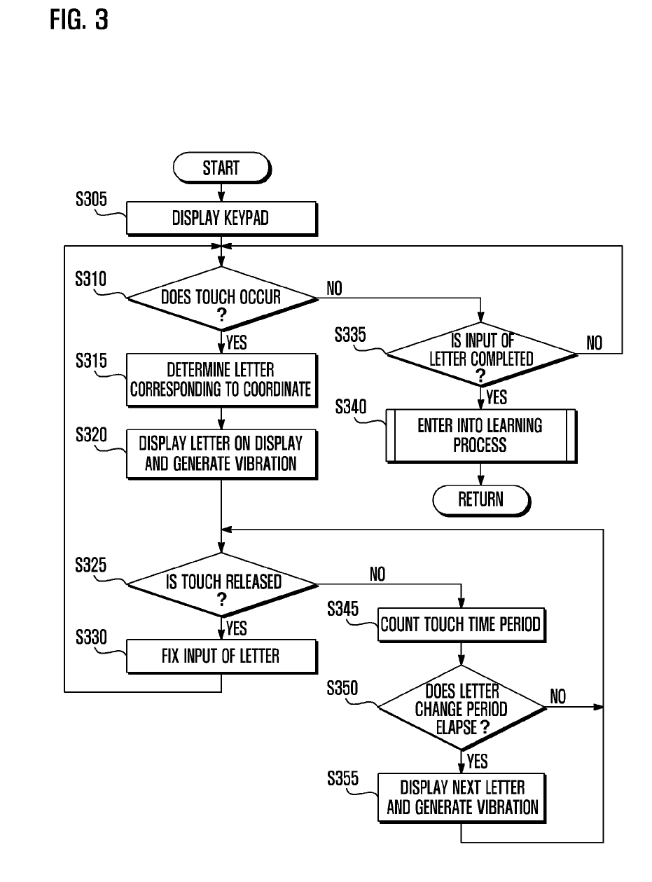

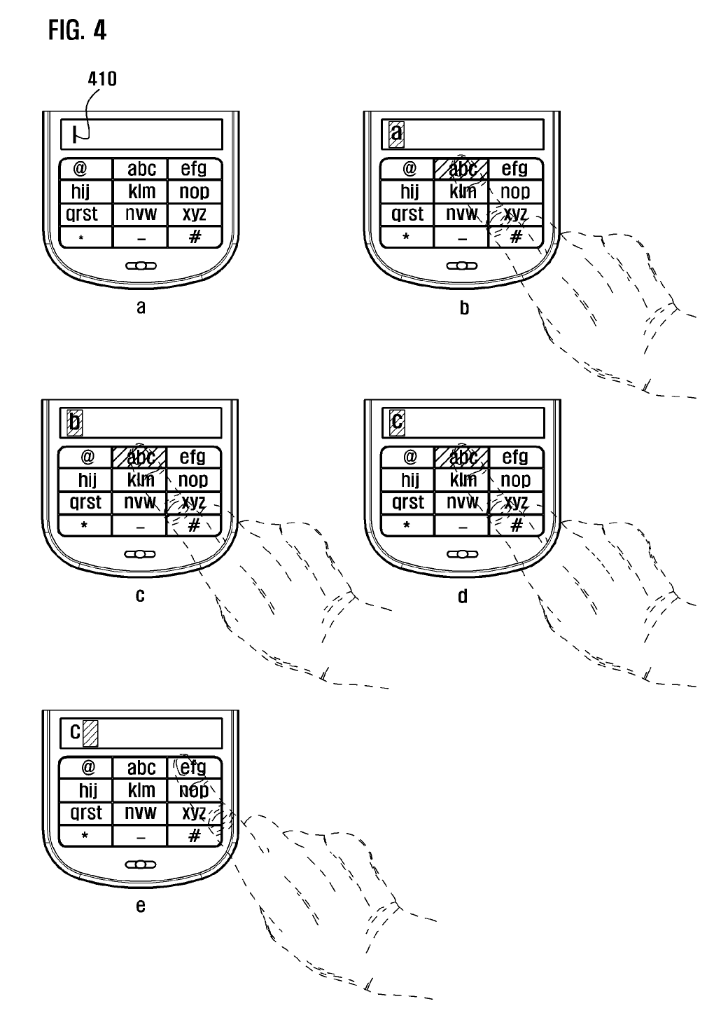

FIG. 3 is a flowchart showing a process of inputting a letter using the automatic input mode according to the exemplary embodiment of the present invention. FIG. 4 is a view showing the input of a small alphabet letter ‘c’ in the automatic input mode according to the exemplary embodiment of the present invention.

First, when the mobile terminal enters into a letter input mode, the control unit 160 of the mobile terminal controls the touch screen 140 to display a keypad for inputting a letter (S305). At least one letter may be allocated to each region of the keypad.

An example related to the above-mentioned process is shown in (a) of FIG. 4. A cursor 410 to confirm the letter input location may be displayed on the display of the mobile terminal.

When the user touches one of the keys on the keypad displayed on the touch screen 140 to input a letter, the touch screen 140 detects the touch. Then, the touch screen 140 generates a touch detection signal indicating the occurrence of the touch on the touch screen 140 and transmits the touch detection signal to the control unit 160, and the control unit 160 recognizes the occurrence of the touch on the touch screen 140 (S310). At the same time, the control unit 160 receives a location where the touch has occurred from the touch screen 140, and the control unit 160 determines a letter corresponding to the coordinate (S315). Upon displaying of the letter, the control unit 160 controls the vibration generator 150 to generate vibration in the mobile terminal (S320). Due to the vibration, the user may recognize that a specific letter is displayed on the mobile terminal in a non-visual method.

An example related to the above-mentioned process is shown in (b) of FIG. 4. In order to input a small alphabet letter of ‘c’, the user touches a key to which small alphabet letters of ‘a’, ‘b’, and ‘c’ are allocated. In this case, since the order of the letters displayed on the display is in alphabetic order, upon touching of the key, the small alphabet letter of ‘a’ is displayed on the display first. Upon display of the letter ‘a’, vibration is generated in the mobile terminal so the user can detect input of the letter.

Thereafter, the control unit 160 determines whether the user releases the touch on the touch screen 140 (S325). When the touch is not released by the user, the control unit 160 determines the time for which the touch is maintained (S345), and the control unit 160 determines whether the letter change period lapses (S350). Upon the lapse of the letter change period, the control unit 160 controls the display to display a letter corresponding to the next in order (S355). At the same time, the vibration generator 150 generates vibration in the mobile terminal. Due to the vibration, the user can recognize the change of the letter displayed on the mobile terminal in a non-visual method. As long as the user does not release the touch on the touch screen, the control unit 160 repeats the above-mentioned steps and sequentially changes the letter displayed on the display of the mobile terminal whenever the letter change period elapses.

Examples related to the above-mentioned process are shown in (c) and (d) of FIG. 4. After the user touches a specific region of the touch screen of the mobile terminal to display ‘a’ on the display, the control unit 160 of the mobile terminal counts the time period for which the touch screen is touched while the touch is being maintained. When the counted time period exceeds the letter change period, as shown in (c) of FIG. 4, the control unit 160 changes the letter displayed on the display to the small alphabet letter of ‘b,’ which is next to the small alphabet letter of ‘a’. Upon change of the letter, vibration is generated in the mobile terminal so the user can recognize the change of the letter in a tactile method. Likewise, after the small alphabet letter of ‘b’ is displayed on the display unit of the mobile terminal, the control unit 160 continuously determines the time period for which the touch is maintained while the touch is being maintained. When the time period exceeds the letter change period, as shown in (d) FIG. 4, the control unit 160 changes the letter displayed on the display to the small alphabet letter of ‘c,’ which is next to the small alphabet letter of ‘b’. Upon change of the letter, vibration is generated in the mobile terminal so the user can recognize the change of the letter in a tactile method.

On the other hand, upon release of the touch on the touch screen 140 by the user, the control unit 160 recognizes the release of touch (S325), and stores the letter displayed on the display unit and fixes input of the letter upon release of the touch(S330). As input of the letter is fixed together with release of the touch, the user may continuously input the next letter without any separate idle time period. Then, the control unit 160 determines whether a touch occurs on the touch screen 140 (S310), and upon occurrence of a touch, the control unit repeats the above-mentioned steps. On the other hand, when a touch does not occur, the control unit 160 determines whether the letter input mode of the mobile terminal is completed (S335). Upon completion of the letter input mode, the control unit 160 enters into a learning process for correcting the letter change period (S340).

An example related to the above-mentioned process is shown in (e) of FIG. 4. That is, upon release of the touch on the touch screen by the user, as shown in (e) of FIG. 4, input of the small alphabet letter of ‘c’ is fixed. Upon fixing of the input of the letter, the cursor 410 to confirm the letter input location moves to the next location and waits for input of another letter by the user.

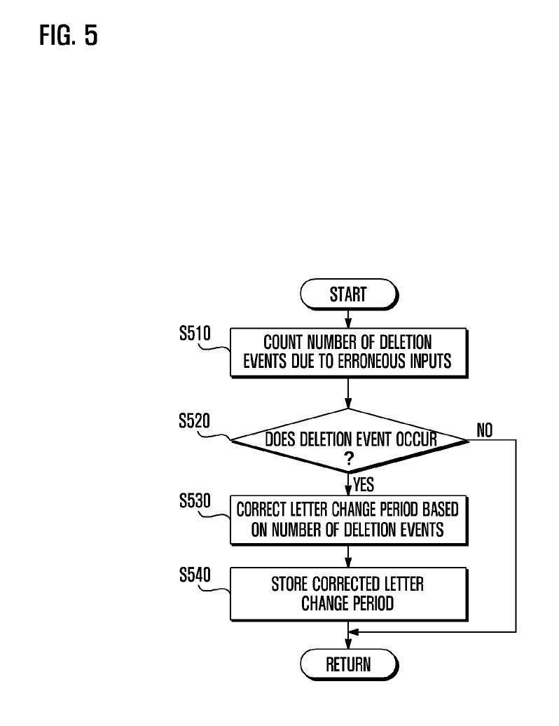

FIG. 5 is a flowchart showing a process of counting the number of times letters are deleted due to erroneous inputs by the user and adapting letter change period in the automatic input mode according to the exemplary embodiment of the present invention.

The control unit 160 counts and stores the number of letters deleted due to erroneous inputs by the user (S510). When the number of letters deleted due to erroneous inputs is more than one, the control unit 160 recognizes this (S520), and corrects the letter change period based on the number of deletion events (S530). As the number of letters deleted increases, the current letter change speed increases, in which case the letter change period decreases. The control unit 160 stores the corrected letter change period (S540), and then, in the automatic input mode, determines whether the letter change period elapses based on the corrected letter change period and the letter is changed at the same time.

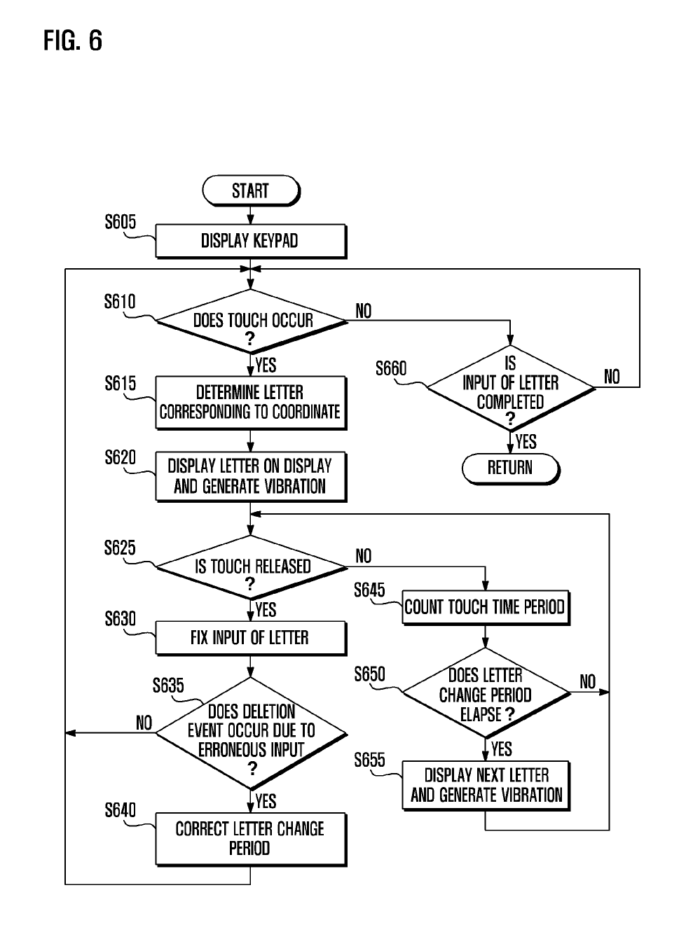

FIG. 6 is a flowchart showing a process of determining the occurrence of a deletion event due to an erroneous input by the user in real time and correcting the letter change period in the automatic input mode according to the exemplary embodiment of the present invention.

The steps S605 to S630 and S645 to S655 of inputting letters in the automatic input mode of the mobile terminal are the same as in the description of FIG. 3. The characteristic feature of the exemplary embodiment of the present invention lies in the process of, after fixing input of a letter (S630), determining occurrence of a deletion event due to an erroneous input (S635), and upon occurrence of the deletion event, correcting a letter change period (S640), by the control unit 160. This process is different from the exemplary embodiment of FIG. 3 in which the number of erroneous inputs is counted during input of letters and a letter change period is corrected only after a letter input mode is completed.

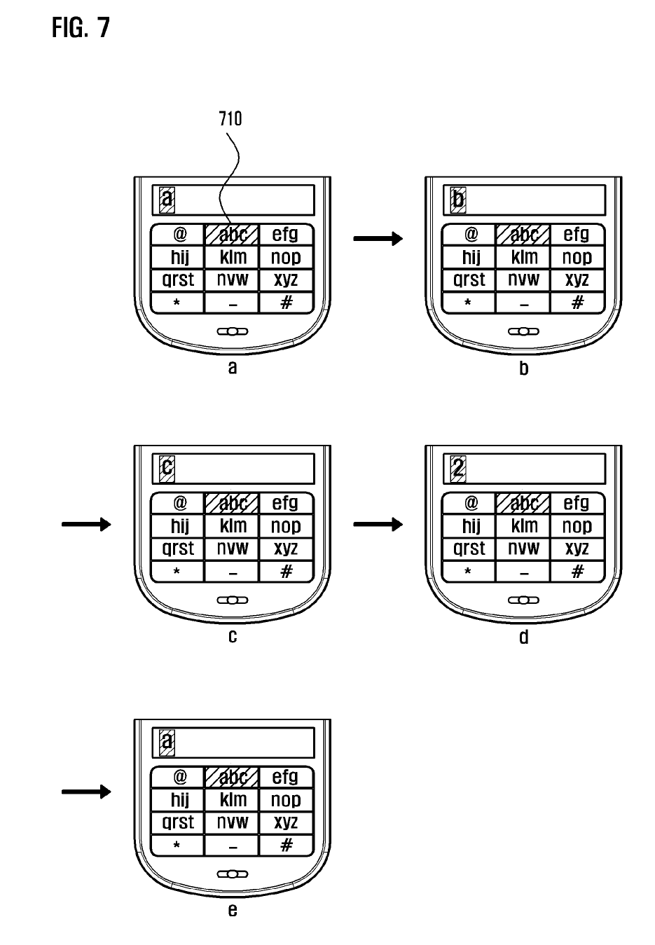

FIG. 7 is an example of sequentially displaying a plurality of letters allocated to a single key during maintenance of a touch on a touch screen by the user in the automatic input mode according to the exemplary embodiment of the present invention.

When the user touches a specific region 710 of the touch screen 140 (it is assumed that ‘a’, ‘b’, ‘c’, and ‘2’ are allocated to the region 710), as shown in (a) of FIG. 7, the first letter of ‘a’ is displayed on the display of the mobile terminal. Then, when the user continuously maintains the touch, as shown in (b), (c), and (d) of FIG. 7, the other characters allocated to the region 710 are sequentially displayed on the display unit whenever the letter change period elapses. After the final letter of ‘2’ in the touched region is displayed on the display, if the user continuously maintains the touch, as shown in (e) of FIG. 7, the first allocated character of ‘a’ is displayed on the display again, so that display of the letters is circularly repeated.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile terminal, comprising:
a touch screen; and
a control unit to determine a location of a touch on the touch screen, to display a letter corresponding to the location, to determine a time period for which the touch continues, and to change the letter displayed on the touch screen when a letter change period lapses.

2. The mobile terminal of claim 1, further comprising a vibration generator to generate a vibration signal when the letter is first displayed and when the letter displayed on the touch screen changes.

3. The mobile terminal of claim 1, wherein a plurality of letters are allocated to single key on the touch screen.

4. The mobile terminal of claim 1, wherein, in a manual input mode, the control unit determines a duration of the letter change period by determining a time period for which a key is continuously pressed.

5. The mobile terminal of claim 4, wherein, in an automatic input mode, the control unit changes the duration of the letter change period by checking for an occurrence of a letter, whose input has been completed, being deleted due to an erroneous input.

6. The mobile terminal of claim 5, wherein the control unit locks in the letter upon release of the touch on the touch screen.

7. A method for inputting a letter in a mobile terminal using a touch screen, the method comprising:
determining a touch has occurred;
determining a location of the touch;
displaying a letter corresponding to the location on a display unit;
determining a time period for which the touch is maintained; and
changing the letter displayed on the display unit when a letter change period lapses.

8. The method of claim 7, further comprising generating vibration when displaying the letter.

9. The method of claim 8, further comprising generating vibration when changing the letter.

10. The method of claim 9, wherein the letter change period is determined according to a time period for which a key is continuously pressed in a manual input mode.

11. The method of claim 9, wherein a plurality of letters are allocated to a single key on the touch screen.

12. The method of claim 11, further comprising locks in the letter when the touch is released.

13. The method of claim 12, further comprising correcting the letter change period by checking for an occurrence of a locked in letter being deleted.

14. The method of claim 12, further comprising correcting the letter change period by determining an occurrence of a locked in letter being deleted.

15. A method for inputting a letter in a mobile terminal using a touch screen, the method comprising:
displaying a keypad on a touch screen;
determining that a single touch of the touch screen has occurred;
determining a location of the single touch and a time duration of the single touch; and
displaying a first letter, a second letter, and a third letter sequentially, the first letter, the second letter, and the third letter corresponding to the location of the single touch,
wherein when the time duration of the single touch exceeds a first time, the displayed first letter is changed to the second letter, and when the time duration of the single touch exceeds a second time, the displayed second letter is changed to the third letter.

16. The method of claim 15, further comprising generating vibration when initially displaying each of the first letter, the second letter, and the third letter.

17. The method of claim 15, further comprising locking in the letter that is displayed when the single touch is released.

18. The method of claim 15, further comprising modifying the first time and the second time by determining an occurrence of a locked in letter being deleted.

19. The method of claim 15, wherein the first time and the second time are determined according to a time period for which a key is continuously pressed in a manual input mode.

20. The method of claim 15, wherein when the time duration of the single touch exceeds a third time, the displayed third letter is changed back to the first letter.
